(19) United States
(12) Patent Application Publication
(10) Pub. No.: US 2023/0189693 A1
(43) Pub. Date: Jun. 22, 2023

(54) Seed Tab Fixture

(71) Applicant: Brian Pic, Pisek, ND (US)

(72) Inventor: Brian Pic, Pisek, ND (US)

(21) Appl. No.: 17/557,777

(22) Filed: Dec. 21, 2021

(51) Int. Cl. A01C 5/06

(52) U.S. Cl. CPC A01C 5/062

(57) ABSTRACT

This application discloses an improved quick fit clamping device and method of use to remove excess movement between a seed boot and a seed row unit. The quick fit clamping device is primarily used on air seeders which have developed excess movement between the seed boot and seed row unit. A cap screw may connect the seed boot to the seed row unit. The quick fit clamping device may be joined to a cap screw without the need to remove the cap screw. Once joined the quick fit clamping device may be configured to apply pressure between the cap screw and the seed row unit, thereby remedying the excess movement.

### CROSS-REFERENCE TO RELATED APPLICATION(S)

None.

### FIELD OF TECHNOLOGY

This disclosure generally relates to seed boot structures attached to agricultural planters and to securing a worn seed boot to an agricultural planter.

### BACKGROUND

Agricultural planters are primarily used to place seeds into the soil for the purpose of seed germination and plant growth. Air seeders are one type of seeder used to plant crops such as small grains, soybeans, corn, and others. Air seeders generally can efficiently plant a large acreage of land. Typically, an air seeder will seed multiple furrows in one pass. An air seeder typically utilizes a seeder row unit to which a seed boot is attached for each furrow. Seeds are stored in a container near the seeder row unit. Then, the seeds flow to the seed boot to be placed in the furrow.

The seed boot may be constructed to include a passage which allows for seeds to pass through and to be deposited into the furrow. The furrow is a narrow trench in the ground made by a disc in which seeds are deposited for seed germination and plant growth. The seed boot may extend from the seeder row unit to the depth in the furrow as desired by planting specifications. Certain air seeders utilize a cap screw to connect the seed boot to a channel on the seed row unit. The channel on the seed boot often comprises a first base ear and a second base ear. Holes in the base ears allow for the cap screw to extend through the base ears and, when the seed boot is connected to the seed row unit, through a hole in the seed boot. This configuration secures the seed boot to the seed row unit.

Over time and with use, the holes in the base ears and seed boot may wear so to allow for excess movement between the seed boot and the seed row unit. Such excess movement can be problematic in the depositing of seeds into the furrow. Traditionally, to remedy this excess wear, the cap screw is removed and components of the seed boot or seed row unit may be replaced or repaired. Alternative devices have been developed wherein the cap screw is removed and then a clamping device is installed on a reinstalled cap screw. The clamping device can apply pressure between the cap screw and seed row unit, thereby removing or reducing the excess movement. With either traditional method of remedying the excess movement, the cap screw must be removed. It is not uncommon that components attached to the seed boot and seed row unit have corroded, and therefore disassembly is difficult. For example, a tube attached to the seed boot through which seeds are moved, may become stuck to the seed boot. The tube may block access to the cap screw, thereby making disassembly difficult.

### SUMMARY

The present invention disclosed herein includes a quick fit clamping device that can be connected to a cap screw without removing the cap screw from a seed boot and seed row unit. The present invention disclosed herein further includes a method of use for the quick fit clamping device. The quick fit clamping device may be utilized to remedy excess movement between a seed boot and a seed row unit.

The quick fit clamping device is generally comprised of a threaded rod, a notched sleeve, a fastener, and a plate. The notched sleeve may be joined to the cap screw. A threaded rod is attached to the notched sleeve and extends distally away from the notched sleeve. The fastener and plate may interface with the threaded rod. The plate is sized to rest on the first base ear and the second base ear. When the fastener is tightened on the threaded rod, pressure is exerted between the plate's location on the base ears and the cap screw where the notched sleeve is joined. This pressure effectively removes the excess movement between the seed boot and the seed row unit. The cap screw does not need to be removed to join the notched sleeve to the cap screw.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is an exemplary first 3D perspective of the quick fit clamping device connected to a seed boot and a seed row unit;

FIG. 2 is an exemplary zoomed in 3D perspective of the quick fit clamping device connected to a seed boot and a seed row unit;

FIG. 3 is an exemplary second 3D perspective of the quick fit clamping device connected to a seed boot and a seed row unit;

FIG. 4 is a first 3D perspective of the quick fit clamping device;

FIG. 5 is a second 3D perspective of the quick fit clamping device; and

FIG. 6 is a 3D perspective of the quick fit clamping device joined to a cap screw.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### Figures Detail

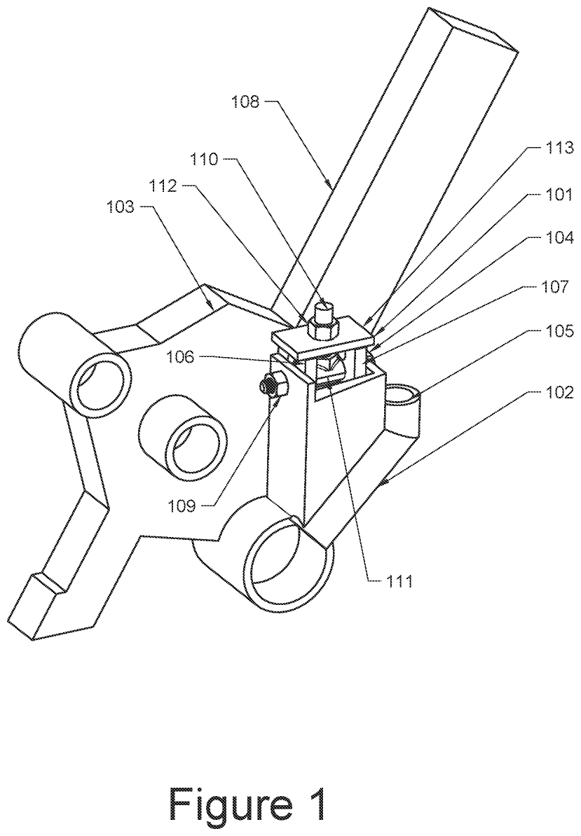

FIG. 1 is an exemplary first 3D perspective of the quick fit clamping device 101 connected to a seed boot 102 and a seed row unit 103. The seed boot 102 as shown in FIG. 1 is a simplified version of a seed boot 102. A seed boot 102 may extend further from the seed row unit 103 or may be in an alternative shape or embodiment. Seed boot 102 shape and size is not relevant to the quick fit clamping device 101. For the quick fit clamping device 101 to be applicable, the seed boot 102 need only be secured to the seed row unit 103 utilizing a cap screw 104.

The seed row unit 103 is attached to a larger planter structure that is generally pulled behind a tractor. A container is attached to the larger planter structure to store seeds. Seeds can be moved from the container to the seed boot 102 passage 105. The seeds can be moved by the movement of air. The seed boot 102 passage 105 may be configured to route the seed to a depth in a furrow which is required by planting specifications. Exemplary seeders which can utilize the quick fit clamping device 101 include seeder models 1590 1690 1890 1895 1990 and 750A sold by John Deere®.

A cap screw 104 is defined as a fastener that extends through the first base ear 106, the seed boot 102, and the second base ear 107. The cap screw 104 secures the seed boot 102 to the seed row unit 103. Some repair manuals regarding seeder models 1590 1690 1890 1895 1990 and 750A sold by John Deere® refer to the cap screw 104 as a cap screw.

The seed row unit 103 is comprised of a first base ear 106, a second base ear 107, and a structure 108. The first base ear 106 and second base ear 107 may extend perpendicularly from the structure 108. The first base ear 106 and the second base ear 107 may be referenced as the base ears or a set of base ears. Some planters may not utilize a perpendicular configuration. A set of holes on the seed boot 102, a first base ear 106 hole, and a second base ear 107 hole are aligned when the seed boot 102 is connected to the seed row unit 103. When aligned, the cap screw 104 may be inserted through the holes. A cap screw nut 109 may be secured to one end of the cap screw 104.

The quick fit clamping device 101 generally comprises a threaded rod 110, a notched sleeve 111, a fastener 112, and a plate 113. The quick fit clamping device 101 is comprised of multiple elements and is not one solid piece. The notched sleeve 111 may be joined to the cap screw 104. A threaded rod 110 is attached to the notched sleeve 111 and extends distally away from the notched sleeve 111. The threaded rod 110 must extend such that it extends from the notched sleeve 111 joined to the cap screw 104 to beyond the top of the set of base ears. The fastener 112 and plate 113 may interface with the threaded rod 110. The plate 113 is sized to rest on the first base ear 106 and the second base ear 107. When the fastener 112 is torqued on the threaded rod 110, pressure is exerted between the plate 113 on the base ears and the cap screw 104 joined to the notched sleeve 111. Torquing is considered the tightening of a fastener 112. This pressure effectively removes the excess movement between the seed boot 102 and the seed row unit 103. The cap screw 104 does not need to be removed to join the notched sleeve 111 to the cap screw 104.

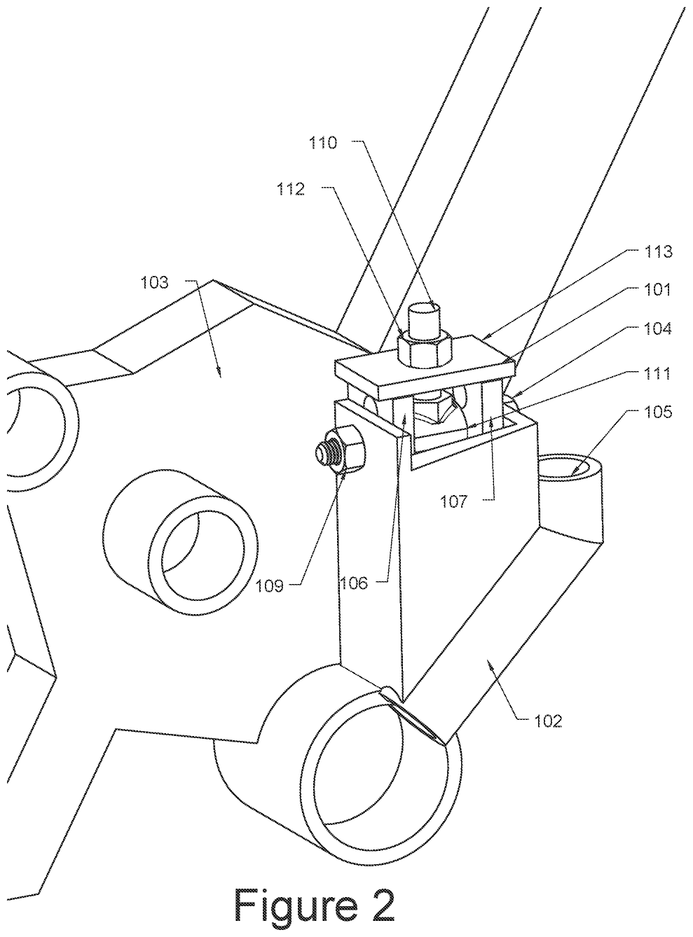

FIG. 2 is an exemplary zoomed in 3D perspective of the quick fit clamping device 101 connected to a seed boot 102 and a seed row unit 103. The first base ears have a top that is opposite to the ground surface or the furrow. The plate 113 rests on the top of the set of base ears. The plate 113 has a hole through which the threaded rod 110 may interface. Interfacing is the act of placing the threaded rod 110 through the hole in the plate 113 and the act of threading the fastener 112 onto the threaded rod 110. Interfacing may be understood as the threaded rod 110 extending through the hole in the plate 113 and the fastener 112. The fastener 112 and the plate 113 may be removed from the threaded rod 110. When the notched sleeve 111 is being joined to the cap screw 104, the fastener 112 and the plate 113 may be removed from the threaded rod 110. The plate 113 may be constructed of any rigid material that is capable of withstanding the force of the fastener 112 being torque against the plate 113. For example, the plate 113 could be constructed from steel or aluminum. The plate 113 may incur some deflection when the fastener 112 is torqued but will generally need to maintain its form. Pressure is not applied through the use of screws, bolts, or other pressure elements downward upon the base ears. Pressure is applied to the plate 113 resting on the top of the base ears. The threaded rod 110 extends upward past the to of the base ears, wherein the notched sleeve 111 is below the top of the base ears.

When the fastener 112 is torqued on the threaded rod 110, pressure against the plate 113 is applied by the fastener 112. That pressure is distributed into the tops of the base ears. The pressure causes a pulling force along the axis of the threaded rod 110 such that the notched sleeve 111 attached to the threaded rod 110, is pulled against the cap screw 104. The force upon the cap screw 104 causes the cap screw 104 to apply lateral pressure upon the set of holes on the seed boot 102. The pressure upon the set of holes on the seed boot 102 increases the friction force between the cap screw 104 and the seed boot 102. The increased friction helps to remedy the excess movement due to worn holes on the base ear holes. A remedy to the excess movement is understood to be the stabilization of the seed boot 102 relative to the seed row unit 103. Seeds may then be consistently placed according to planting specifications.

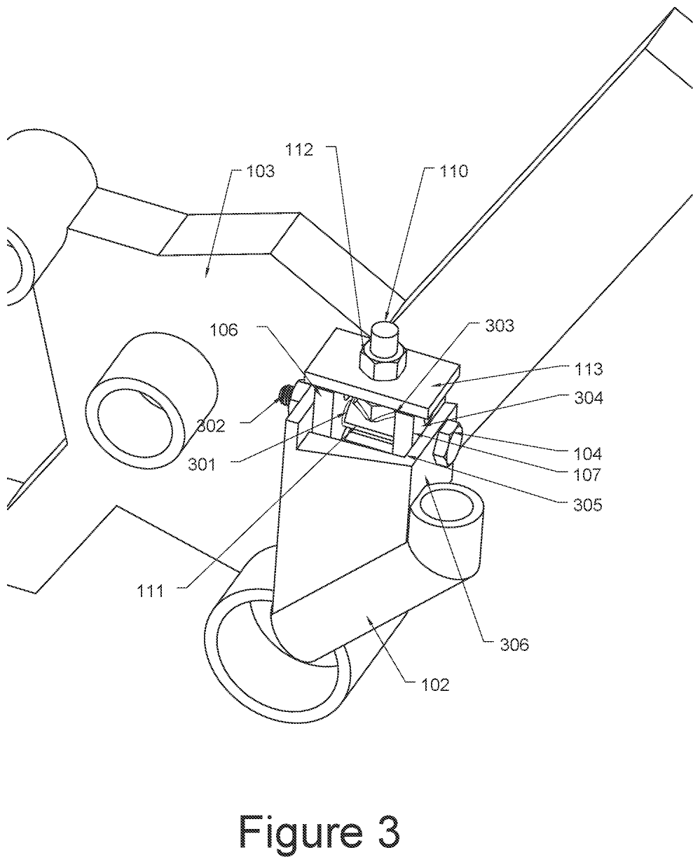

FIG. 3 is an exemplary second 3D perspective of the quick fit clamping device 101 connected to a seed boot 102 and a seed row unit 103. The first base ear 106 has an first inner surface 301 and an first outer surface 302. The second base ear 107 has a second inner surface 303 and a second outer surface 304. The cap screw 104 extends past the first outer surface 302 to past the second outer surface 304. Between the first inner surface 301 and the second inner surface 303 the notched sleeve 111 is joined to the cap screw 104.

The seed boot 102, as shown in this embodiment, takes the form of a C-shape if looking from a top perspective. The seed boot 102 has a boot inner surface 305 and a boot outer surface 306. The boot inner surface 305 is shaped to sit adjacent to the first outer surface 302 on the first base ear 106 and adjacent to the second outer surface 304 on the second base ear 107. The cap screw 104 extends past the boot outer surface 306 on each respective end of the cap screw 104. On each respective end a fastener is utilized to keep the cap screw 104 in place.

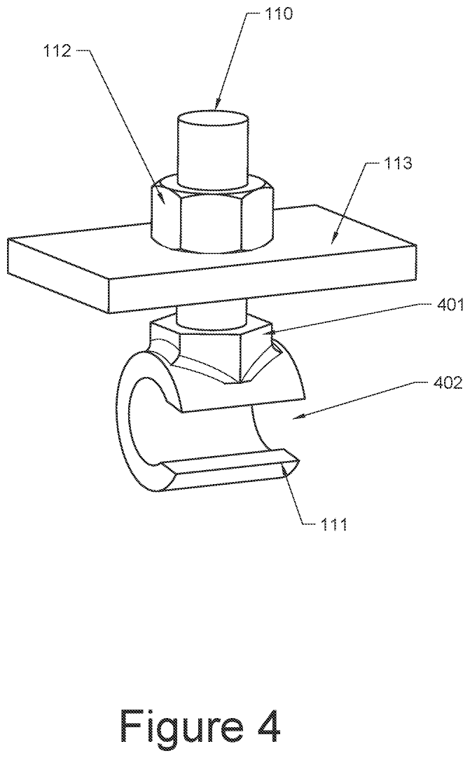

FIG. 4 is a first 3D perspective of the quick fit clamping device 101. The quick fit clamping device 101 is generally comprised of a threaded rod 110, a notched sleeve 111, a fastener 112, and a plate 113. The threaded rod 110 may be configured to be any length along its axis to accommodate for a specific application. The threaded rod 110 further may comprise threads upon which a nut may be screwed, a smooth surface, or a different surface to accommodate other fastener types. When the threaded rod 110 is configured with threads, the fastener 112 may be a nut with internal threads sized to screw onto the threaded rod 110. When the threaded rod 110 has a smooth surface, the fastener 112 may comprise of any type appropriate to attach to a smooth rod. The threaded rod 110 may comprise a bolt that is welded to the notched sleeve 111. As shown in FIG. 4, the threaded rod 110 is a bolt attached to the notched sleeve 111 by welds. In other embodiments, the threaded rod 110 may be secured to the notched sleeve 111 by constructing the threaded rod 110 and the notched sleeve 111 in one piece. Such construction, for example, could be done in a mold. In the figure, a hex head 401 is shown. The hex head 401 is not present in all embodiments of the quick fit clamping device 101. Alternatively, the threaded rod 110 may simply be a rod attached to the notched sleeve 111.

The notched sleeve 111 may be a round tube or pipe which has a notch 402 removed. An exemplary notched sleeve 111 constructed from a pipe may be a pipe cut to a length less than the distance between the first inner surface 301 and the second inner surface 303, material on the pipe is cut out to create the notch 402. The notched sleeve 111 is not required to have a tight tolerance with the first inner surface 301 or the second inner surface 303. Using a pipe as described allows for simple and low cost manufacturing. The notch 402 must be sized such that it can slide over a cap screw 104. The clearance between the size of the notch 402 in relation to the cap screw 104 simply requires that the notch 402 is larger than the diameter of the cap screw 104. The notched sleeve 111 is understood to include alternative embodiments including but not limited to a solid block with a notch 402, a pipe with a notch 402, a tube with a notch 402, or any other similar element. The solid block in such embodiment requires a notch 402 to be removed such that the solid block may be joined to the cap screw 104. The act of placing the notched sleeve 111 onto the cap screw 104 is the act of joining the notched sleeve 111 and the cap screw 104.

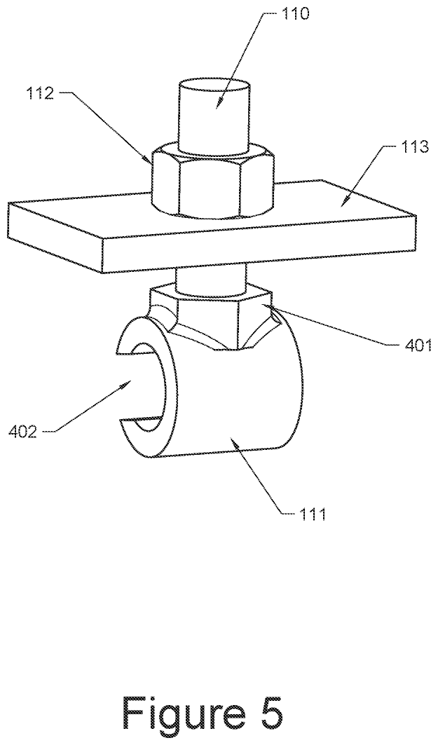

FIG. 5 is a second 3D perspective of the quick fit clamping device 101. The material of the threaded rod 110, the notched sleeve 111, the fastener 112, and the plate 113 may be constructed from many different types of metals, including but not limited to steel and aluminum. The quick fit clamping device 101 may also be comprised of other materials, including composites, plastics, or other materials with strength and rigidity properties similar to steel or aluminum.

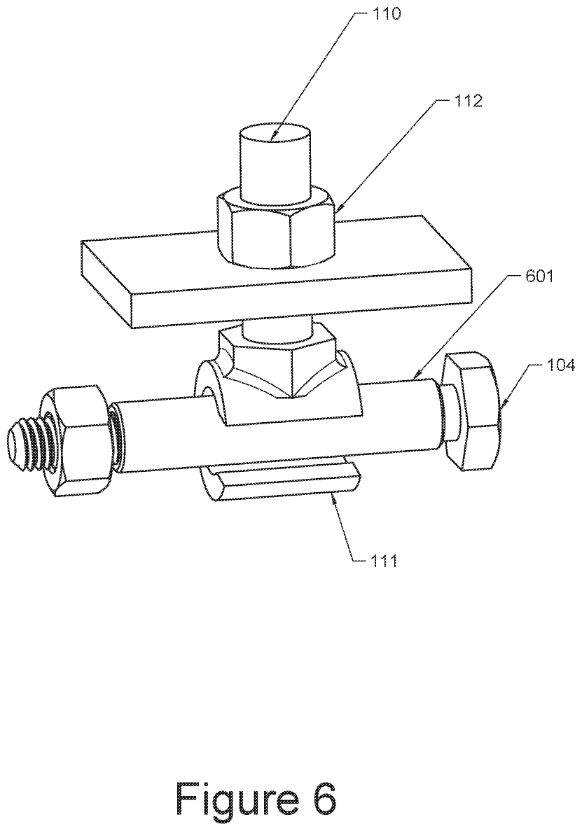

FIG. 6 is a 3D perspective of the quick fit clamping device 101 joined to a cap screw 104. The cap screw 104, as shown in FIG. 6, has a raised surface 601 upon which the notched sleeve 111 may join. In other embodiments, the cap screw 104 may have threads along part or all its axis.

The method in which the quick fit clamping device 101 is utilized includes the steps of joining the notched sleeve 111 to the cap screw 104, interfacing the threaded rod 110 through the plate 113, and torquing the fastener 112 on the threaded rod 110.

Joining the notched sleeve 111 to the cap screw 104 is the act of placing the notched sleeve 111 onto the cap screw 104 by sliding the notch 402 on the notched sleeve 111 over the cap screw 104. Before interfacing the threaded rod 110 through the plate 113, the threaded rod 110 would need to be orientated or rotated to extend upward past the top of the base ears. Once the threaded rod 110 and the plate 113 are interfaced, the plate 113 should rest upon the top of the base ears. Torquing the fastener 112 is the next step wherein the fastener 112 is torqued to a significant extent such that pressure is applied between the cap screw 104 and the top of the base ears. The pressure must be significant enough to remedy any excess movement.

### Explanation of Exemplary Language

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A quick fit clamping device comprising:
a notched sleeve, the notched sleeve joined to a cap screw, the cap screw secures a seed boot to a seed row unit, the cap screw having a diameter, the seed row unit having a set of base ears, the set of base ears having a top, the cap screw extending through the set of base ears and through the seed boot, the notched sleeve further comprising a notch, the notch being larger than the diameter of the cap screw, the notched sleeve is constructed from a pipe, wherein the notch is created by cutting material from the pipe;
a threaded rod, the threaded rod is attached to the notched sleeve, the threaded rod extending distally away from the notched sleeve beyond the top of the set of base ears, the threaded rod is threaded;
a plate, the plate having a hole through which the threaded rod is interfaced, the plate rests on the top of the set of base ears; and
a fastener, the fastener is torqued on the threaded rod, the fastener is a nut, the fastener is torqued to an extent such that excess movement is remedied between the seed row unit and the seed boot.

2. A quick fit clamping device comprising:
a notched sleeve, the notched sleeve joined to a cap screw, the cap screw secures a seed boot to a seed row unit, the cap screw having a diameter, the seed row unit having a set of base ears, the set of base ears having a top, the cap screw extending through the set of base ears and through the seed boot, the notched sleeve further comprising a notch, the notch being larger than the diameter of the cap screw;
a threaded rod, the threaded rod is attached to the notched sleeve, the threaded rod extending distally away from the notched sleeve beyond the top of the set of base ears;
a plate, the plate having a hole through which the threaded rod is interfaced, the plate rests on the top of the set of base ears; and
a fastener, the fastener is torqued on the threaded rod.

3. The quick fit clamping device of claim 2, wherein the threaded rod is threaded.

4. The quick fit clamping device of claim 3, wherein the fastener is a nut.

5. The quick fit clamping device of claim 2, wherein the threaded rod is a bolt, the bolt having a hex head wherein the hex head is welded to the notched sleeve.

6. The quick fit clamping device of claim 5, wherein the threaded rod is threaded.

7. The quick fit clamping device of claim 6, wherein the fastener is a nut.

8. The quick fit clamping device of claim 2, wherein the notched sleeve is constructed from a pipe, wherein the notch is created by cutting material from the pipe.

9. The quick fit clamping device of claim 8, wherein the threaded rod is threaded.

10. The quick fit clamping device of claim 9, wherein the fastener is a nut.

11. The quick fit clamping device of claim 2, wherein the notched sleeve is a solid block.

12. The quick fit clamping device of claim 2, wherein the threaded rod and the notched sleeve is one piece.

13. The quick fit clamping device of claim 2, wherein the fastener is torqued to an extent such that excess movement is remedied between the seed row unit and the seed boot.

14. A method of using a quick fit clamping device comprising:
joining a notched sleeve to a cap screw, the cap screw secures a seed boot to a seed row unit, the cap screw having a diameter, the seed row unit having a set of base ears, the set of base ears having a top, the cap screw extending through the set of base ears and through the seed boot, the notched sleeve further comprising a notch, the notch being larger than the diameter of the cap screw, the notched sleeve is attached to a threaded rod, the threaded rod is oriented to extend beyond the top of the set of base ears;
interfacing the threaded rod through a plate and a fastener, the plate is resting on the top of the set of base ears; and
torquing the fastener on the threaded rod.

15. The method of claim 14 wherein the seed boot is secured to the seed row unit while joining the notched sleeve to the cap screw.

16. The method of claim 15 wherein torquing is applied with pressure significant to remedy excess movement between the seed boot and the seed row unit.
